(19) United States
(12) Patent Application Publication
(10) Pub. No.: US 2023/0140626 A1
(43) Pub. Date: May 4, 2023

(54) BULK METALLIC GLASS STRUCTURES FOR HYDROGEN APPLICATIONS

(71) Applicant: Supercool Metals LLC, Branford, CT (US)

(72) Inventors: Jittisa KETKAEW, New Haven, CT (US); John CHAY, Hamden, CT (US); Jan SCHROERS, Guilford, CT (US); Evgenia PEKARSKAYA, New York, NY (US)

(21) Appl. No.: 17/980,469

(22) Filed: Nov. 3, 2022

Related U.S. Application Data
(60) Provisional application No. 63/275,474, filed on Nov. 4, 2021.

(51) Int. Cl. F17C 5/00

(52) U.S. Cl. CPC F17C 5/00; F17C 2221/012; F17C 2205/0352; F17C 2205/037; F17C 2265/065; F17C 2205/0323

(57) ABSTRACT

The present invention relates to bulk metallic glass (BMG) structures used for hydrogen applications such as hydrogen infrastructure and vehicle applications. The BMG structure may include a main body with at least one opening, wherein the main body is made from a BMG material. The BMG structure may be configured to receive, store, transport and/or dispense hydrogen fuel in a form of fluid including one of gas, liquid, compressed gas or liquid, cryo-compressed hydrogen, and a combination thereof. The BMG structure may be configured to be under a direct exposure to hydrogen, wherein hydrogen is on the internal surface of the structure and is not on the exterior of the structure during operation.

### CROSS-REFERENCE TO RELATED APPLICATIONS

This application claims the benefit of Provisional U.S. Patent Application No. 63/275,474 filed Nov. 4, 2021, the entire disclosure of which is herein incorporated by reference.

### BACKGROUND OF THE INVENTION

Hydrogen is a versatile energy carrier and plays a vital role in the future energy transformation due to resource abundancy and a low carbon footprint. However, hydrogen can cause embrittlement in most metals. Therefore, it is generally challenging to efficiently produce, store, transport and use hydrogen fuel in the form of gas or liquid, especially under high pressure.

The reliability and durability of materials used for a hardware remain one of the biggest challenges for hydrogen applications such as hydrogen infrastructure and vehicle. It is one of the major technical challenges for the widespread adoption of hydrogen as a fuel for transportation. Hydrogen infrastructure and vehicle applications described in the present invention are related to components used in production, compression, storage, containment, distribution, transfer, dispensing, metering, sensing, monitoring, purification of hydrogen, as well as in pipelines and power generation systems, including fuel cells, where components are in direct contact with hydrogen fuel.

The challenge for material selection for hydrogen applications comes from direct hydrogen exposure under harsh operating conditions during storing and delivering of hydrogen at high pressure and low temperature. Hydrogen is well-known for causing embrittlement in many materials, especially metals, leading to degradation of ductility, strength, and toughness in a broad range of alloys. Hydrogen-compatible materials have stringent property requirements, especially the ones expected to be used under direct hydrogen exposure at a high pressure, low temperature, and have a long life-expectancy. Generally, acceptable materials for usage in a hydrogen environment include austenitic steels, some stainless steels, aluminum alloys and copper alloys. On the other hand, a long list of common structural metal alloys is deemed incompatible with hydrogen for most applications, including martensitic steels, nickel and nickel alloys, titanium and titanium alloys, cast iron, and electropolished or welded parts made from these materials. It is important to note that all metals compatible with hydrogen are alloys with low strength and low hardness, particularly those with a yield strength of less than 500 MPa and with Vickers hardness below 250. It is known that most materials with high strength and high hardness are sensitive to hydrogen embrittlement due to the fact that the microscopic structure of these materials accelerates hydrogen absorption and diffusion and leads to hydrogen-assisted cracking. Furthermore, most metal structures are often joined or constructed into a subsystem or system level using welding. Welding creates points of stress concentration, and sites for hydrogen to penetrate into the metal's structure, leading to hydrogen embrittlement. To date, there is no ideal and practical structural material candidate for hydrogen applications.

Bulk metallic glasses (BMG) are a class of materials that have a disordered and homogeneous atomic structure, unlike traditional metals that have crystalline atomic structures. Due to their unique structure, they exhibit various desirable properties, such as high strength, high elasticity, corrosion-resistance, and excellent cryogenic performance. Due to their high specific strength, BMG components may also have lighter weight. Despite various efforts, however, the suitability of BMGs for hydrogen applications remains inconclusive.

### SUMMARY OF THE INVENTION

The present invention relates to bulk metallic glass (BMG) structures used for hydrogen applications such as hydrogen infrastructure and vehicle.

The BMG structure may comprise a main body with at least one opening, wherein the main body is made from a BMG material. The BMG structure may be configured to receive, store, transport and/or dispense hydrogen fuel in a form of fluid including one of gas, liquid, compressed gas or liquid, cryo-compressed hydrogen, and a combination thereof. The BMG structure may be configured to be under a direct exposure to hydrogen, wherein hydrogen is on the internal surface of the structure and is not on the exterior of the structure during operation. The BMG structure may have a tubular or hollow cylinder structure and have a diameter between 1 mm and 500 mm and overall ratio of a diameter to length between 0.1 and 40, preferably between 0.2 to 40.

The BMG structure may have a tubular or hollow cylinder structure and has a wall thickness between 0.025 mm and 25 mm.

The BMG structure may further comprise a connector as part of the main body or is attached to the main body, the connector configured to connect the main body and another component.

The BMG structure may be made by thermoplastic forming (TPF) method, and the TPF method is one or a combination of compression molding, extrusion, blow molding, stretch blow molding, rolling and hydroforming.

The BMG structure may be made by casting or injection molding.

The BMG material may comprise Zr, Ti, Ni, or Cu with a weight percent equal to or more than 50 wt %.

The BMG may be one of the following alloy families: ZrTiCuNiBe, ZrTiCuBe, ZrCuBe, ZrNbCuNiAl, ZrAlNiCu, ZrCuAlNi, ZrCuBe, TiZrBeFe, TiZrBe, TiZrBeFeNb, TiZrCuPdSn, NiSiB, NiCrP, NiCrNbPB, NiCrSiB, NiCrMoSiBP, NiTiZrAl, NiPdPB, NiPdSiP, CuZrAlBe, CuZrHfA.

The BMG structure may be a hydrogen fuel dispensing nozzle.

The BMG structure may be a breakaway coupling.

The BMG structure may be a receptacle of a vehicle for hydrogen refueling.

The BMG structure may be a valve, the valve being one of relief valves, check valves and safety valve.

The BMG structure may be a fitting, the fitting being one of tube fitting, pipe fitting, tube adapter, glands, sleeves, plugs, elbows, tees, and crosses.

The BMG structure may be used as a connector or fastener between systems or subsystems that facilitates storage and transportation of hydrogen media, the hydrogen media being a liquid, gas, compressed liquid or compressed gas, or their combination.

The BMG structure may be a bipolar plate for fuel cells.

The BMG structure may have a practical geometry that allows to operate under pressure between 20 MPa to 400 MPa, preferably 0.1 MPa to 400 MPa, and/or flow rate of up to 800 g/s, preferably 1,000 g/s, at an operating temperature between 300° C. and −260° C. without losing its structural integrity required for its function.

### BRIEF DESCRIPTION OF THE DRAWINGS

FIG. 1(a) shows a sketch of one example of a BMG structure of the present invention, wherein the structure is a hydrogen nozzle within a dispensing system for refueling vehicles.

FIG. 1(b) shows a cross-section of the BMG structure of FIG. 1.

FIG. 2(a) shows a sketch of one example of a BMG structure of the present invention for hydrogen fitting.

FIG. 2(b) shows a cross-section of the BMG structure of FIG. 2.

FIG. 3 shows a cross-section of a BMG structure of the present invention, wherein the structure is a hydrogen receptacle for a fuel cell vehicle.

FIG. 4 shows a sketch of one example of a BMG structure of the present invention, wherein the structure is a bipolar plate.

FIG. 5 shows a side view of a cross-section of the BMG structure of FIG. 4, highlighting the channel within the structure.

FIG. 6 shows a flow chart of one example of forming process, thermoplastic forming (TPF), of BMG structures of the present invention.

### DETAILED DESCRIPTION OF THE INVENTION

The present invention relates to bulk metallic glass (BMG) structures used for hydrogen applications, such as hydrogen infrastructure and vehicle, that are capable of bearing high pressures required for storage and/or transport of compressed hydrogen gas or liquid. The structure may maintain an operating pressure between 20 MPa to 400 MPa, preferably 0.1 MPa to 400 MPa, and/or flow rate up to 800 g/s, preferably 1,000 g/s. The structure may be under direct exposure to hydrogen gas or liquid with operating temperature between 300° C. and −260° C. where hydrogen is in a liquid state, for example at −255° C.

Surprisingly, we found that some BMG alloys such as ones containing Zr, Ti, Cu and Ni as dominant species are compatible for hydrogen applications, unlike most metals with high strength and high hardness that suffer hydrogen embrittlement. We found that these BMG alloys, which exhibit high yield strength and high fracture toughness, and which are used in the present invention, are not susceptible to hydrogen embrittlement and are compatible with hydrogen environment. Specific example of these hydrogen-compatible BMGs are ZrTiCuNiBe, ZrTiCuBe, ZrCuBe, ZrNbCuNiAl, ZrAlNiCu, ZrCuAlNi, ZrCuBe, TiZrBeFe, TiZrBe, TiZrBeFeNb, TiZrCuPdSn, NiTiZrAl, NiPdPB, NiPdSiP, NiSiB, NiCrP, NiCrNbPB, NiCrSiB, NiCrMoSiBP, CuZrAlBe, CuZrHfAl. These BMG alloys form strong short-range order at the microscopic level that prevents the formation of metallic hydrides, which is one of the notable causes of hydrogen embrittlement in metals. Moreover, when these BMG alloys are used to fabricate BMG products through a thermoplastic forming (TPF) technique, the BMG products have excellent performance under a hydrogen environment as BMGs processed through TPF processes always reach a more stable equilibrium state where the short-range ordering is dominating, making them particularly resistant to hydrogen embrittlement.

The BMG structure for hydrogen applications may comprise a main body with at least one opening, wherein the main body is made from a BMG material, and wherein the structure functions to receive, store, transport and dispense hydrogen fuel in a form of fluid or gas and is under a direct exposure to hydrogen gas, liquid, or compressed gas or liquid, where hydrogen is on the internal surface of the structure and is not on the exterior of the structure during operation. The BMG structure of the present invention is capable of operating as a standalone component, or it may be combined into multiple parts that make up a subsystem or a system. The multiple pieces of the BMG structure may be connected by welding, adhesive, or mechanical gripping or locking mechanism, such as threads or shrink fitting.

The BMG structure of the present invention may have a tubular or hollow cylindrical structure and have an overall ratio of the diameter to length in between 0.1 to 40. It can have wall thicknesses between 0.025 mm and 25 mm.

The BMG structure can comprise a connector as part of the main body or attached to the main body for the purpose of connecting the main body to another component of the operating system. The main body of the BMG structure may have features designed for integration of the structure to other components, including other BMG components or other materials, including metals, polymers and ceramics.

The BMG structure may have Young's modulus greater than 10 GPa and yield strength greater than 1200 MPa.

The BMG structure may be produced through casting, injection molding, die casting, or a TPF process. TPF may be performed below 800° C. The TPF techniques used to fabricate the BMG structure of the present invention include, but not limited to blow molding, extrusion, compression molding, stretch blow molding, rolling, shearing, soldering, and over-casting and over-molding or a combination of these methods. The BMG components of the present invention may be formed through a TPF process in the BMG's supercooled liquid state, and, as a result, the high-pressure bearing BMG components may have crystallinity of less than 10%. It has been known in the art that BMG materials with crystallinity exceeding 10% suffer from property deterioration, especially for mechanical properties. A critical capability offered by the present invention is that a high-pressure bearing BMG structure, especially when produced by a TPF process, has a uniform and consistent properties, and has a homogeneous glass state throughout the entire piece.

Specific examples of high-pressure bearing BMG components may be hydrogen dispensing nozzles, breakaway couplings, vehicle's receptacles, relief valves, check valves, safety valves, adapter fitting, tubing, tube fittings, pipes, tube adapters, glands, sleeves, plugs, elbows, tees, crosses and fasteners.

Another example of a BMG structure of the present invention is a bipolar plate used in proton-exchange membrane fuel cells, such as ones used to power vehicles or in electrolyzers for hydrogen production.

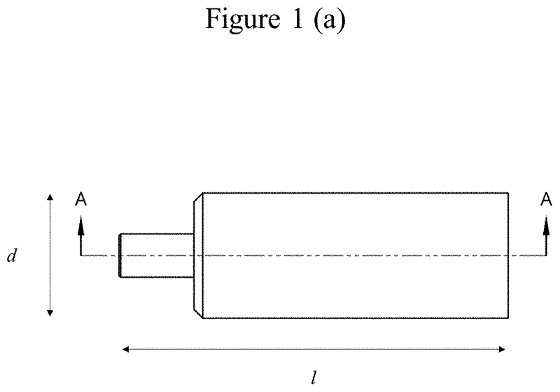

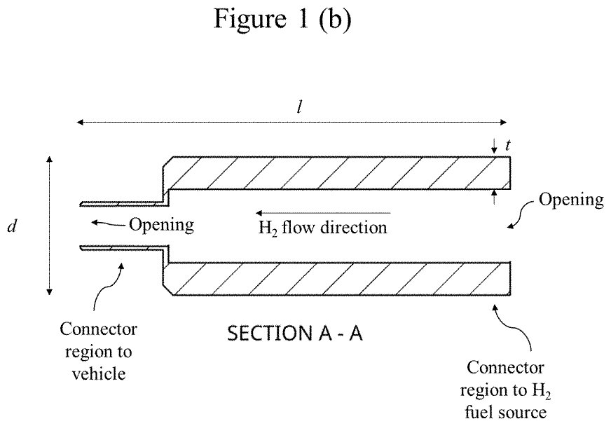

FIG. 1(a) shows a sketch of one example of a BMG structure of the present invention that is a hydrogen fueling nozzle. FIG. 1(b) shows a cross-section of the BMG structure of FIG. 1(a). The BMG hydrogen dispensing nozzle comprises two openings, an inlet and an outlet that allow for the hydrogen fuel, gas or liquid and their compressed forms to flow through the nozzle. The BMG hydrogen dispensing nozzle may have a connector region to a vehicle and a connector region to a hydrogen fuel source. The BMG fueling nozzle may be constructed in one piece or an assembly of multiple pieces. In one embodiment, the BMG component has an overall shape of a cylindrical tube with an overall length, l, that is larger than the diameter, d, and a wall thickness, t. The BMG structure of the present invention may have thin walls and lightweight while exhibiting high strength and high hardness.

The BMG dispensing component may have a minimum wall thickness of 0.025 mm and the largest thickness no more than 25 mm. The diameter may be between 1 mm and 500 mm. The overall ratio of a diameter to length may be between 0.1, preferably 0.2, to 40. The hydrogen fueling nozzle can be used to transfer gas or liquid hydrogen from a station or storage system into vehicles, such as passenger vehicles, medium- and heavy-duty trucks, forklifts, buses, trains, ships, drones, airplanes and various off-road vehicles.

Traditional crystalline metals, especially the ones used for structural applications, such as high strength steels, which have high strength and hardness, suffer from hydrogen embrittlement and exhibit a ductile-to-brittle transition at low temperature (between 0° C. and cryogenic temperatures) and are not qualified for high-pressure hydrogen applications. Current state-of-the-art materials for hydrogen applications are austenitic stainless steels, such as stainless steel 316L. However, due to low yield strength and low hardness, stainless steel 316L structures for hydrogen infrastructure are large, heavy and have thick walls due to the required wall thickness to withstand a sufficient pressure and a required flow rate for hydrogen fuel storage and transportation.

The BMG structure of the present invention may have a practical geometry that allows to operate under pressure between 20 MPa to 400 MPa, preferably 0.1 MPa to 400 MPa, and/or flow rate of up to 800 g/s, preferably 1,000 g/s at an operating temperature between 300° C. and −260° C. without losing its structural integrity required for its function.

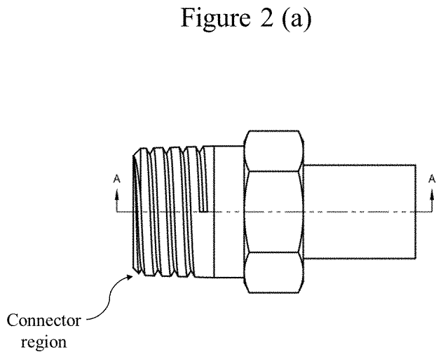

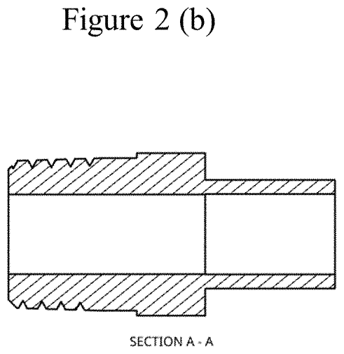

FIG. 2(a) shows a sketch of one example of a BMG structure of the present invention that is a high-pressure tube fitting. FIG. 2(b) shows a cross-section of the BMG structure of FIG. 2(a). The structure has two openings. The BMG tube fitting functions by joining parts of high-pressure hydrogen fuel systems and allowing hydrogen fuel to flow between the systems while preventing leakages between two or more systems. The BMG tube fitting may connect the systems by welding, adhesives or mechanical gripping or locking mechanism, such as threads and shrink fitting.

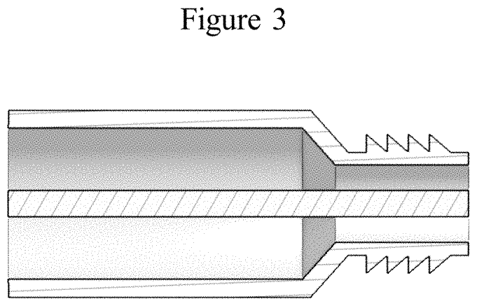

FIG. 3 shows a cross-section of a BMG structure of the present invention wherein the structure is a hydrogen receptacle used in a fuel cell vehicle to receive hydrogen fuel from the fueling station. The hydrogen receptacle can engage to a hydrogen dispensing nozzle through a mating feature.

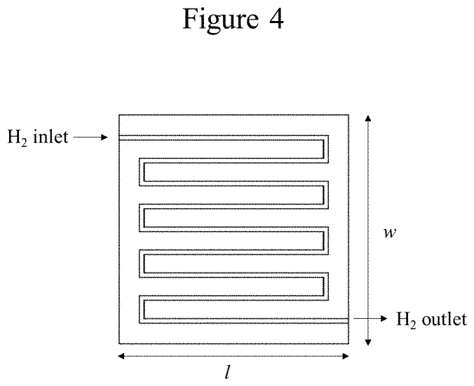

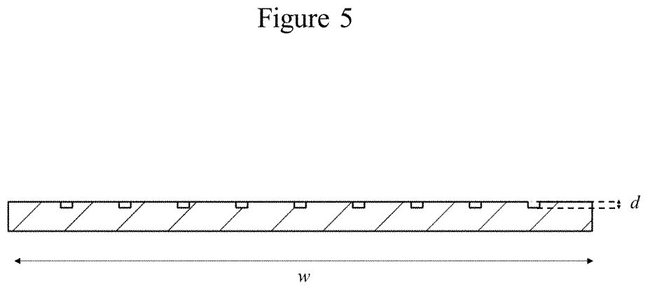

FIG. 4 shows a sketch of one example of a BMG structure of the present invention, wherein the structure is a bipolar plate. FIG. 5 shows a side view of a cross-section of the BMG structure of the present invention of FIG. 4, highlighting the channels within the structure.

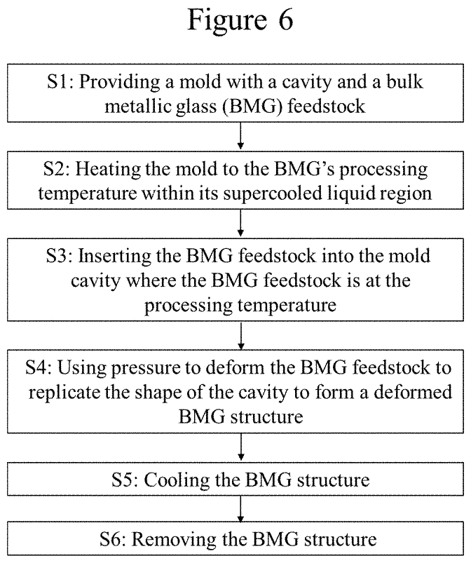

Referring to FIG. 6, one example of the TPF method for fabrication of a BMG structure of the present invention, is described in a flowchart.

In step S1, a mold with a cavity with a negative feature of the desired BMG structure and a BMG feedstock are provided. The shape of the cavity is designed according to the shape of the BMG structure that needs to be formed. The mold can be made of one or more of various materials, such as brass, steel, stainless steel, non-metals, such as alumina, polymers and a combination thereof. The BMG feedstock is specifically designed and engineered for fabrication of the BMG product.

In step S2, the mold is heated up to a processing temperature, which is in a supercooled liquid region between the glass transition temperature and the crystallization temperature of the BMG.

In step S3, the BMG feedstock specifically designed for the structure to be fabricated is inserted into the mold cavity and heated to its pre-determined processing temperature. The BMG feedstock that is provided separately to the mold is inserted into the mold cavity, covering the opening of the mold cavity, before or after the mold temperature reaches the processing temperature.

In step S4, after the temperature of the BMG feedstock reaches the processing temperature, which allows the BMG feedstock to become viscous and moldable, pressure, such as gas or liquid pressure or through a mechanical press, is applied to the BMG feedstock such that the BMG feedstock deforms towards the surface of the mold cavity. The BMG feedstock deforms until reaching the surface of the cavity and replicating the shape of the cavity. The pressure is selected to allow for a complete forming of the BMG final part. The duration of deforming the BMG feedstock, the processing temperature, and the applied pressure are pre-determined to control the thickness, crystallinity, and other properties of the BMG flexible element that is being formed. The deformation duration is selected to be shorter than the amount of time that causes substantial crystallization, such that crystallinity of the BMG flexible element to be formed is minimized to be less than 10%.

In step S5, once the BMG feedstock is completely deformed to take the shape of the mold, the BMG product is cooled below its glass transition temperature to form a solidified BMG structure.

In step S6, the BMG structure is removed from the mold cavity. The total time that the BMG is heated to the processing temperature is below the available time window before the BMG reaches crystallization. The applied pressure is selected to be larger than the flow stress of the BMG feedstock.

Although only certain embodiments of the present invention have been described in detail above, those skilled in the art will readily appreciate that many modifications, such as those in size and shape, are possible in the embodiments without materially departing from the novel teachings and advantages of the present invention. Accordingly, all such modifications are intended to be included within the scope of the present invention.

1. A bulk metallic glass (BMG) structure comprising:
a main body with at least one opening,
wherein the main body is made from a BMG material;
wherein the BMG structure is configured to receive, store, transport and/or dispense hydrogen fuel in a form of fluid including one of gas, liquid, compressed gas or liquid, cryo-compressed hydrogen, and a combination thereof, and is configured to be under a direct exposure to hydrogen; and
wherein hydrogen is on the internal surface of the structure and is not on the exterior of the structure during operation.

2. The structure of claim 1, wherein the BMG structure has a tubular or hollow cylinder structure and have a diameter between 1 mm and 500 mm and overall ratio of a diameter to length between 0.1 and 40.

3. The structure of claim 1, wherein the BMG structure has a tubular or hollow cylinder structure and has a wall thickness between 0.025 mm and 25 mm.

4. The structure of claim 1, wherein the BMG structure further comprises a connector as part of the main body or is attached to the main body, the connector configured to connect the main body and another component.

5. The structure of claim 1, wherein the BMG structure is made by thermoplastic forming (TPF) method, and the TPF method is one or a combination of compression molding, extrusion, blow molding, stretch blow molding, rolling and hydroforming.

6. The structure of claim 1, wherein the BMG structure is made by casting or injection molding.

7. The structure of claim 1, wherein the BMG material comprises Zr, Ti, Ni, or Cu with a weight percent equal to or more than 50 wt %.

8. The structure of claim 1, wherein the BMG is one of the following alloy families: ZrTiCuNiBe, ZrTiCuBe, ZrCuBe, ZrNbCuNiAl, ZrAlNiCu, ZrCuAlNi, ZrCuBe, TiZrBeFe, TiZrBe, TiZrBeFeNb, TiZrCuPdSn, NiSiB, NiCrP, NiCrNbPB, NiCrSiB, NiCrMoSiBP, NiTiZrAl, NiPdPB, NiPdSiP, CuZrAlBe, CuZrHfA.

9. The structure of claim 1, wherein the BMG structure is a hydrogen fuel dispensing nozzle.

10. The structure of claim 1, wherein the BMG structure is a breakaway coupling.

11. The structure of claim 1, wherein the BMG structure is a vehicle's receptacle for hydrogen refueling.

12. The structure of claim 1, wherein the BMG structure is a valve, the valve being one of relief valves, check valves and safety valve.

13. The structure of claim 1, wherein the BMG structure is a fitting, the fitting being one of tube fitting, pipe fitting, tube adapter, glands, sleeves, plugs, elbows, tees, and crosses.

14. The structure of claim 1, wherein the BMG structure is used as a connector or fastener between systems or subsystems that facilitates storage and transportation of hydrogen media, the hydrogen media being a liquid, gas, compressed liquid or compressed gas, or their combination.

15. The structure of claim 1, wherein the structure is a bipolar plate for fuel cells.

16. A method of making the BMG structure of claim 1.

17. The method of claim 16, wherein the method comprises a thermoplastic forming step, the step comprises one or more of compression molding, extrusion, blow molding, stretch blow molding, rolling, and hydroforming.
